(19) United States
(12) Patent Application Publication
(10) Pub. No.: US 2021/0339270 A1
(43) Pub. Date: Nov. 4, 2021

(54) APPARATUS FOR RECLAIMING HYDRAULIC AND DIELECTRIC FLUIDS

(71) Applicant: SCIENCE & PRACTICE LIMITED LIABILITY COMPANY, Moscow (RU)

(72) Inventors: Nikolay Anatolevich TUZ, Moscow (RU); Denis Valerevich KURGANOV, Moscow (RU)

(21) Appl. No.: 17/282,250

(22) PCT Filed: Oct. 4, 2018
(86) PCT No.: PCT/RU2018/000655

§ 371 Date: Apr. 1, 2021

(30) Foreign Application Priority Data
Oct. 2, 2018 (RU) 2018134589

(51) Int. Cl. B03C 5/02; C10M 175/00; B01D 17/04; B01D 35/06

(52) U.S. Cl. CPC B03C 5/02; C10M 175/005; C10N 2040/08; B01D 35/06; B01D 17/042

(57) ABSTRACT

The invention relates to devices for purifying hydraulic and dielectric fluids (oils and fuels) of mechanical impurities and dissolved and dispersed water. It could be used in any fields where clean and contaminated fluids are used. The apparatus for reclaiming hydraulic and dielectric fluids comprises a vacuum tank with an atomizer, a vacuum pump, a dielectric fluid feed pump and dielectric fluid removal pump, all of said pumps being connected to the tank by pipes, and an electric filter, wherein the atomizer is disposed in the lower part of the vacuum tank, is arranged vertically with a spray member oriented upward and consists of a T fitting with a lower inlet for fluid and with a lateral inlet for air, a mixing chamber disposed above the T fitting, and a spray member with a nozzle, said spray member being disposed above the mixing chamber, and the electric filter comprises a housing with an inlet pipe and outlet pipe, a high-voltage power supply, a composite unit disposed inside the housing and consisting of current-carrying plates and dielectric spacers with apertures for current-carrying and heavy-duty fastening elements, a front plug and rear plug, and is current-carrying and heavy-duty fastening elements, wherein the surface of the current-carrying plates is provided with a porous ceramic dielectric coating. The technical result is increasing the efficiency of purifying and reclaiming dielectric fluids; increasing the useful volume of the vacuum tank without increasing the dimensions thereof; reducing the dispersivity of the fluid sprayed from the atomizer; simplifying the design; stabilizing the electromagnetic field of the electric filter; increasing the surface area of the electric filter by creating a developed surface of current-carrying filter elements without changing filter size and mass; improving reliability and ease of use; and reducing materials consumption.

### FIELD OF THE INVENTION

The invention relates to devices for purifying hydraulic and dielectric fluids (oils and fuels) of mechanical impurities and dissolved and dispersed water. It could be used in any fields where clean and contaminated fluids are used.

### BACKGROUND

The prior art discloses an apparatus for dehydrating insulation (transformer) oils, comprising a vacuum tank, vacuum pump, oil feed/removal pumps, atomizer, atomizer air inlet, a pack consisting of solid and gauze caps (SU1771796 A1, publ. Oct. 30, 1992).

The disadvantages of this design are as follows: very difficult-to-make vacuum tank, availability of additional elements in the tank (solid and gauze caps) complicating the design, small useful volume of vacuum tank, low oil pumping capacity, low transformer oil breakdown voltage after dehydration, large oil flow dispersion at spray atomizer outlet and, consequently, low-efficient oil dehydrating off oil-dissolved water.

The prior art discloses an electric purifier of dielectric fluids consisting of a housing, restraining plates, set of connecting electrodes, float cutoff valve, longitudinal electrical baffles, purified fluid inlet and outlet pipes, insulating pads, covers, mounting studs, power wiring and fastening elements (SU691199, publ. Oct. 15, 1979).

The disadvantage of this device is unstable electromagnetic field due to non-controllable high-voltage power supply of electric filter, variation of electromagnetic field as contaminations are accumulated

The prior art discloses a filter for purifying dielectric fluids characterized in that it comprises a housing consisting of two parts interconnected by flange connections, and housing is fixed at 20°±5°, with the upper part comprising collecting electrode power supply, and the lower one includes a pack of collecting electrode plates with apertures 1 mm wide covering all electrode area, and dielectric plates have apertures 5 mm wide (RU158784, publ. Jan. 20, 2016).

The disadvantages of this device are as follows: low efficiency of dielectric fluid purifying, unstable electromagnetic field due to non-controllable high-voltage power supply of electric filter, variation of electromagnetic field as contaminations are accumulated, poor reliability, unhandiness, high materials consumption.

The prior art discloses an apparatus for purifying hydraulic and dielectric fluids MEFO-200, comprising vacuum chamber, vacuum pump, dielectric fluid feed pump and dielectric fluid removal pump, electric filters (Ruscable.ru. Articles, Power Engineering, Innovative Technologies and Oil Purifying Equipment. Publ. Dec. 29, 2011, https://www.ruscable.ru/article/Innovacionnye_texnologii_i_oborudovanie/).

The main disadvantages of MEFO-200 are as follows: low-efficient removal of dissolved water and mechanical impurities, small useful volume of vacuum tank, large dispersion at vacuum spraying, unstable electromagnetic field, poor moisture protection, large weight-size parameters and high materials consumption, poor reliability and unhandiness.

### DISCLOSURE OF THE INVENTION

The technical problem is creation of an apparatus able to purify and reclaim hydraulic and dielectric fluids effectively using vacuum dehydrating and degassing, and controllable electrostatic filter.

The technical result is increasing the efficiency of purifying and reclaiming dielectric fluids; increasing the useful volume of the vacuum tank without increasing the dimensions thereof; reducing the dispersivity of the fluid sprayed from the atomizer: simplifying the design; stabilizing the electromagnetic field of the electric filter; increasing the surface area of the electric filter by creating a developed surface of current-carrying filter elements without changing filter size and mass; improving reliability and ease of use; and reducing materials consumption.

The technical result is achieved due to the fact that an apparatus for reclaiming hydraulic and dielectric fluids comprises a vacuum tank with an atomizer, a vacuum pump, a dielectric fluid feed pump and dielectric fluid removal pump, all of said pumps being connected to the tank by pipes, and an electric filter, wherein the atomizer is disposed in the lower part of the vacuum tank, is arranged vertically with a spray member oriented upward and consists of a T fitting with a lower inlet for fluid and with a lateral inlet for air, a mixing chamber disposed above the T fitting, and a spray member with a nozzle, said spray member being disposed above the mixing chamber, and the electric filter comprises a housing with an inlet pipe and outlet pipe, high-voltage power supply, composite unit disposed inside the housing and consisting of current-carrying plates and dielectric spacers with apertures for current-carrying and heavy-duty fastening elements, a front plug and rear plug, and current-carrying and heavy-duty fastening elements, wherein the surface of the current-carrying plates is provided with a porous ceramic dielectric coating.

Atomizer fluid inlet pressure is minimum 6 atm.

The atomizer is hermetically seated in the lower part of the vacuum tank so that its upper part with a spray member and nozzle is inside the tank, and its lower part with T fitting, fluid and air inlets, and mixing chamber is disposed outside the tank.

Vacuum tank pressure is maximum −0.8 atm.

Temperature of fluid fed to the tank is 45-95° C.

Two faceplates with openings are installed in the atomizer, one of them is for fluid and the other one is for air.

Fluid faceplate is installed at fluid pipe end upstream from the mixing chamber, with a central opening for fluid passing through it to the mixing chamber.

Air faceplate is hermetically seated in the upper part of T fitting with a central opening for a fluid pipe passing through it and with openings located on the circumference for air passing through them to the mixing chamber.

Current-carrying plate aperture for current-carrying stud has inner teeth.

High-voltage power supply is current and voltage controlled and is configured on the outer part of the electric filter housing for short-circuit operation.

High-voltage power supply is configured to operate at 1250 V-4750 V.

Through holes with a diameter sufficient for user's fingers penetration are arranged on plugs' face.

There is a seal on each plug circumference.

### BRIEF DESCRIPTION OF DRAWINGS

FIG. 1—Schematic diagram of the apparatus;

FIG. 2—Schematic view of the atomizer assembly;

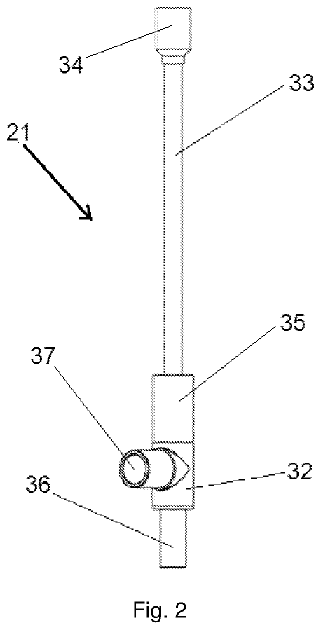

FIG. 3—Schematic view of disassembled atomizer;

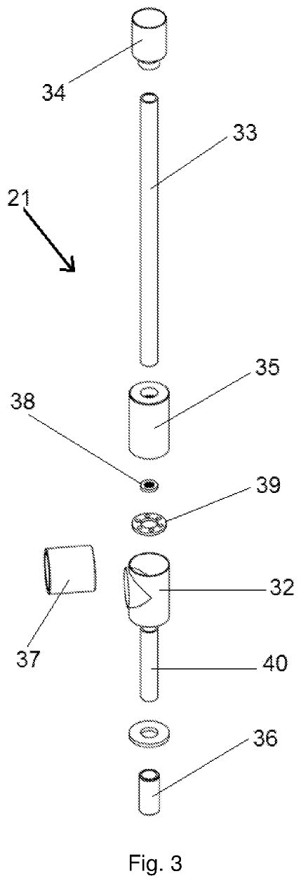

FIG. 4—Schematic view of atomizer interior structure;

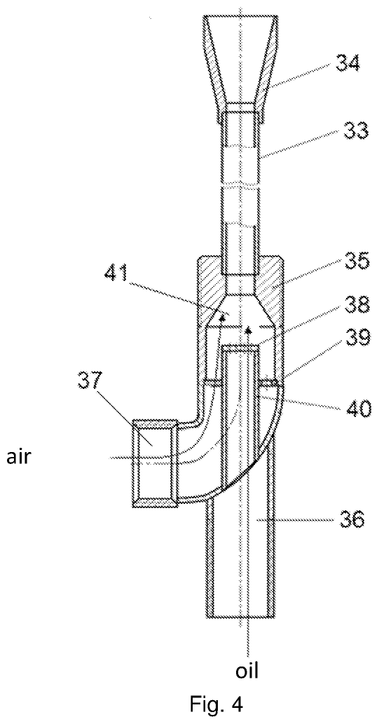

FIG. 5—Electric filter assembly, without housing;

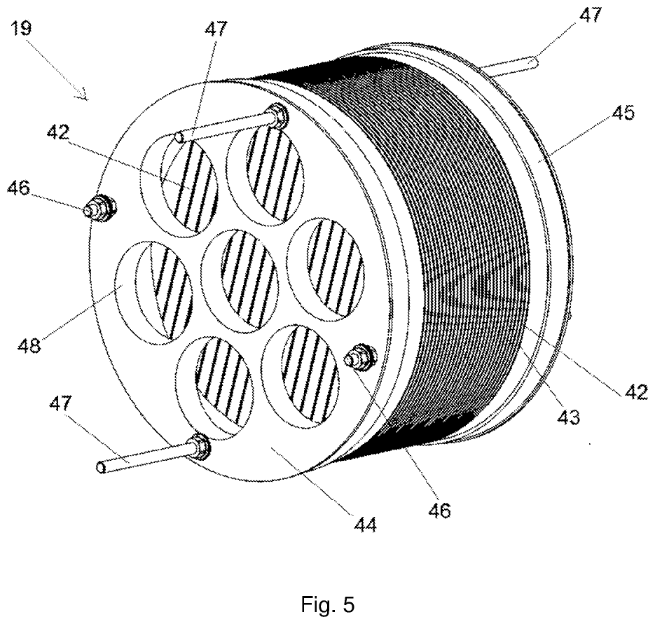

FIG. 6—Current-carrying plate;

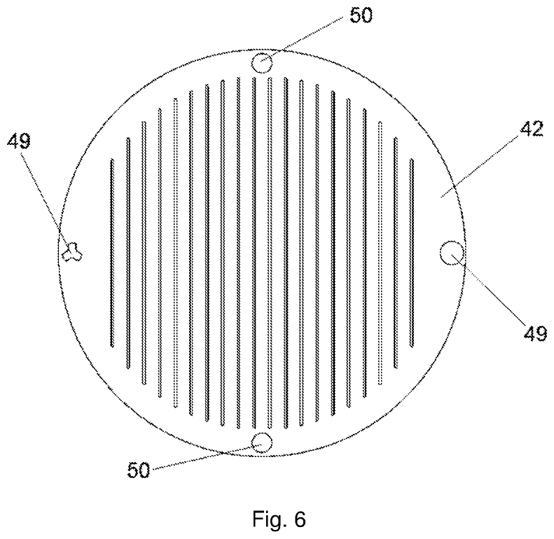

FIG. 7—Dielectric spacer;

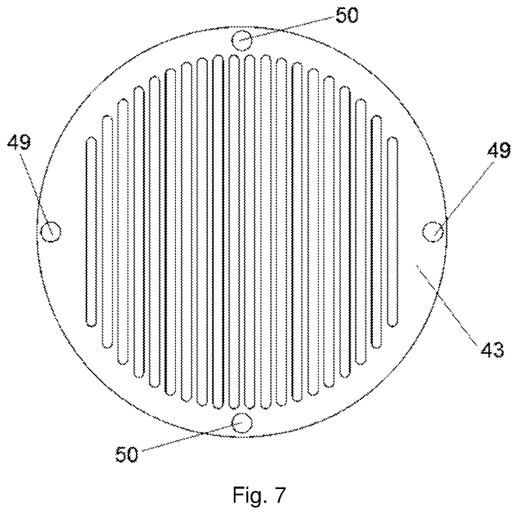

FIG. 8—Plug.

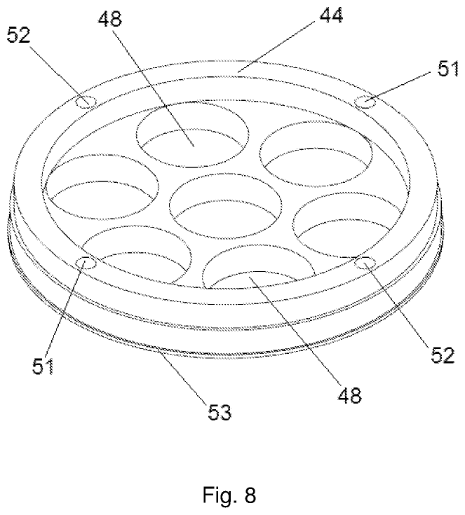

### EMBODIMENT OF THE INVENTION

The claimed apparatus for reclaiming hydraulic and dielectric fluids operates using vacuum dehydrating and degassing, and electrostatic purifying. It is designed for purifying any dielectric fluids with permittivity of 1-3 units, e.g. oils, fuels.

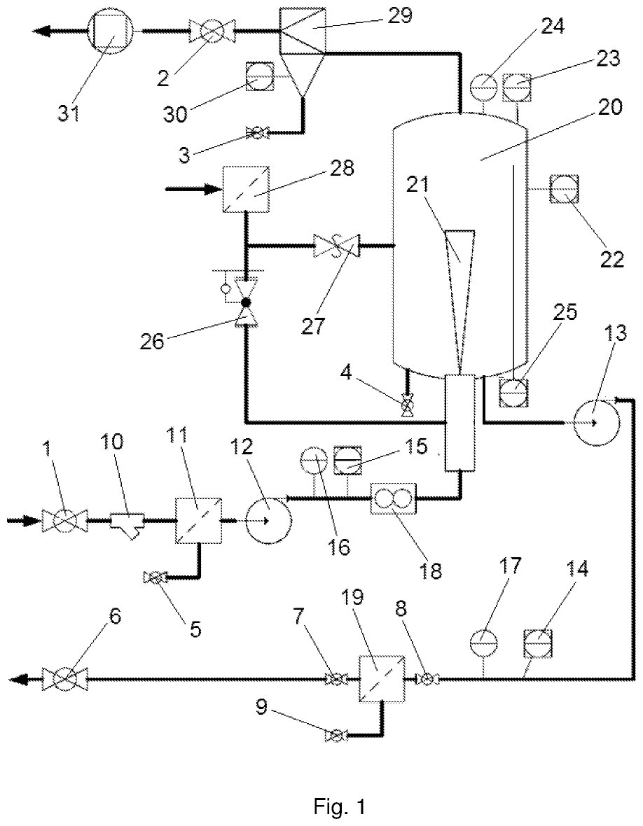

FIG. 1 illustrates a schematic hydraulic-pneumatic diagram of the apparatus for purifying and reclaiming hydraulic and dielectric fluids, consisting of valves 1-9, strainer 10, coarse filter 11, hydraulic feed pump 12, hydraulic removal pump 13, pressure sensor 14, pressure and temperature sensor 15, thermal pressure gauges 16, 17, flow meter 18, electric filter 19, vacuum tank 20 with atomizer 21, emergency level sensor 22, vacuum sensor 23, vacuum meter 24, main level sensor 25, flow regulator 26, pressure relief valve 27, vacuum tank breathing air filter 28, mist extractor 29, emergency level sensor 30, vacuum pump 31.

Vacuum dehydrating and degassing are performed in the vacuum tank 20. The atomizer 21 is installed in the lower part of the vacuum tank (in the bottom) vertically with a spray member oriented upward. Purified fluid through a pipeline (main line), having passed preliminarily through a strainer and coarse filter, is delivered by the hydraulic feed pump 12 to the atomizer 21, which sprays fluid to the vacuum tank 20.

The vacuum tank 20 is cylinder-shaped with constant heightwise diameter, made of, for example, any known metal, including stainless. Tank head and bottom could be as flat as dished (torispherical, elliptical). A foam suppression device could be arranged in the upper tank part.

Atomizer 21 consists of T fitting 32 with lower fluid (oil) inlet 36 and lateral air inlet 37, housing 35 of mixing chamber 41 disposed above the T fitting 32, spray member 33 with nozzle 34 above the housing 35 of the mixing chamber 41. The atomizer 21 is hermetically seated in the lower part of the vacuum tank 20 (in the bottom) vertically with a spray member oriented upward, so that its upper part with spray member 33 and nozzle 34 is inside the tank 20, and its lower part with T fitting 32, fluid and air inlets, and mixing chamber is disposed outside the tank bottom.

Two faceplates 38, 39 with openings are installed in the atomizer (one is for fluid and the other one is for air).

Fluid faceplate 38 is installed at fluid pipe 40 end upstream from the mixing chamber 41, with a central opening for fluid passing through it to the mixing chamber 41.

Air faceplate 39 is hermetically seated in the upper part of T fitting 32 with a central opening for a fluid pipe 40 passing through it and with openings located on the circumference (around the central opening) for air passing through them to the mixing chamber 41. Air is supplied directly to the mixing chamber 41, that enables to obtain finer mist.

Spray member 33 with nozzle 34 is over mixing chamber 41, above the level of treated fluid pumped by pump 13 from vacuum tank 20. All elements of the atomizer 21 are interconnected by welds.

A washer (not shown) is welded on the outside of the tank bottom in line with an aperture for atomizer installation, the atomizer is screwed into internal thread of this washer (there is an external thread on the upper outside of the mixing chamber).

Hydraulic feed pump 12, which delivers fluid to atomizer 21, is connected to atomizer 21 inlet (lower inlet 36 of T fitting 32) by a stainless corrugated pipe.

Hydraulic removal pump 13 is connected to a hole in the lower part of the vacuum tank 20 (in the bottom) by a stainless corrugated pipe, and is designed to remove treated (dehydrated) fluid from vacuum tank 20 and to maintain fluid level in the vacuum tank 20 below atomizer 21 spray member 33 level.

Vacuum pump 31 is connected by a pipeline through mist extractor 29 to the vacuum tank 20 in its upper part and is designed to remove air, supplied through atomizer 21, together with water boiled in vacuum, and to maintain pressure maximum −0.8 atm in vacuum tank 20.

Due to vacuum in tank 20 air is supplied to the atomizer through lateral inlet 37 of T fitting 32 from atmosphere through air filter 28, through a pipeline. Amount of air supplied is regulated by means of flow regulator 26 disposed on the pipeline.

Atomizer 21 inlet fluid pressure fed by feed pump 12 is minimum 6 atm to get finer dispersion of dehydrated fluid. Mixing fluid (oil) with air inside atomizer 21 facilitates jet splitting to oil mist. Air supplied through atomizer 21 is removed together with water boiled in vacuum by vacuum pump 31, which maintains pressure maximum −0.8 atm in vacuum tank 20. Treated (dehydrated) oil is removed from vacuum tank 20 by removal pump 13, maintaining oil level in the vacuum tank below atomizer 21 spray member 33 level.

After fluid dehydrating, degassing and pumping from the vacuum tank by the hydraulic removal pump, the fluid passing through the pipeline comes to electrostatic purification.

Electrostatic purification is performed by at least one electric filter 19, which consists of a mechanical part, namely, cylindrical housing with inlet and outlet pipes, composite unit disposed inside the housing and consisting of even number of current-carrying plates 42 and odd number of dielectric spacers 43 with apertures for current-carrying 49 and heavy-duty 50 fastening elements, front plug 44 and rear plug 45, and current-carrying 46 and heavy-duty 47 fastening elements (studs), and of an electrical part, namely, high-voltage current and voltage controlled power supply (not shown), fixed on the outer part of the electric filter housing and configured for short-circuit operation, electrical harness and grounding circuit.

Current-carrying plates 42 and dielectric spacers 43 have apertures. Width of current-carrying plates 42 apertures is less than width of dielectric spacers 43 apertures. Apertures of current-carrying plates 42 cover all area and together with apertures of dielectric spacers 43 form contamination collecting cells.

Surface of current-carrying plates 42 is provided with a porous ceramic dielectric coating, e.g. oxidation. Besides, aperture in current-carrying plates 42 for current-carrying stud 49 has inner teeth.

Front plug 44 and rear plug 45 are disposed in front and rear parts of electric filter, respectively, in front of and behind the composite unit of current-carrying plates 42 and dielectric spacers 43, they are round, to size of internal diameter of a cylindrical housing, with through apertures 51, 52 along the edges for current-carrying 46 and heavy-duty 47 fastening elements, and designed to keep a set of plates and spacers assembled and to fix them in the required position in the housing. Besides, on the plugs' face there are additional through holes 48 stiffening plugs, reducing their materials consumption, and also improving installation and deinstallation of plugs, since these holes have a diameter sufficient for user's fingers penetration, grasping plug with fingers for its deinstallation/installation. Besides, there is a seal 53 on each plug circumference for better hermetization and fixation of plugs with a set of plates and spacers in the cylindrical housing.

In contrast to analogues the high-voltage power supply is fixed on the outer part of the electric filter housing. Such position of the high-voltage power supply enables maximum efficient operation of the electric filter avoiding interference in operation of elements disposed inside the housing, ensuring safety in case of the power supply failure, improving its serviceability, installation/deinstallation, reducing materials consumption as a whole.

High-voltage current and voltage continuously controlled power supply stabilizes electric field, expanding its operation modes to short-circuit operation as a normal state. Electromagnetic (electrostatic) field control enables to adjust electric filter operation to different types of contaminations or their combinations. The best results of dielectric fluids purifying are achieved at 1250 V-4750 V.

Porous ceramic dielectric coating on current-carrying plates enables to expand the area of focusing elements. The said coating in combination with the high-voltage controlled power supply enables to remove mechanical impurities from dielectric fluids (oils, fuels) most effectively.

Furthermore, when using the said coating, the secondary static field occurs during passing of contaminated dielectric fluids. The secondary static field occurs due to passing of differently charged particles of contaminations through a gauze of the filter electromechanical part.

An aperture of current-carrying plates for current-carrying stud has inner teeth for better contact of current-carrying stud with current-carrying plates and for better stabilization of electromagnetic field. Surface of current-carrying plates is provided with a porous ceramic dielectric coating to expand their effective area.

High-voltage power supply generates magnetic field and holds it constant by variation of current and voltage. The best results of dielectric fluids purifying have been achieved at 1250 V-4750 V. When voltage below 1250 V is selected, no required electric field occurs magnetizing of impurities is weak, and when voltage above 4750 V is selected, there is additional magnetizing of impurities and separation of impurities from the electric filter.

The apparatus operates as follows.

Treated dielectric fluid, for example, oil passes through the [pipeline through valve 1, strainer 10 and coarse filter 11, is pumped in by pump 12 and with pressure, temperature and momentary discharge being controlled by sensors 15, 16 and 18 is supplied through the pipeline under pressure minimum 6 atm through the lower inlet 36 to T fitting 32 of atomizer 21. Atomizer 21 is disposed in tank 20 vertically with a spray member 33 oriented upward. Due to vacuum in tank 20 the set amount of air, regulated by flow regulator 26 disposed on the pipeline, is supplied to atomizer 21 through lateral inlet 37 of T fitting 32 from atmosphere through air filter 28 and flow regulator 26 through the pipeline. Oil with air through the openings of faceplates 38, 39, disposed in T fitting 32, enter mixing chamber 41, are mixed, and the obtained mixture through spray member 33 of atomizer 21 and nozzle 34 is sprayed into tank 20 as fine oil mist. Air is supplied directly to mixing chamber 41, but not under atomizer 21, that enables to obtain finer mist. Maximum pressure −0.8 atm in tank 20 is maintained by vacuum pump 31, due to this the mixture is heated, and dispersed and dissolved water is evaporated and removed by vacuum pump 31 through mist extractor 29. Balance between air supplied to atomizer 21 and air enriched with water evaporated from oil and removed from tank 20 is maintained by vacuum pump 31 and mixing chamber 41 of atomizer 21. Thus, watered oil is supplied to the device inlet, and at the outlet of the apparatus there is dehydrated oil and moist air removed by vacuum pump 31. Dehydrated and degassed dielectric fluid through the lower hole in tank 20 is pumped through the pipeline by pump 13, maintaining fluid level in tank 20 below atomizer 21 spray member 33, and monitoring pressure and temperature by sensors 14 and 17, is supplied through the pipeline from pump 13 to electric filter 19, where contaminated dielectric fluid (oil, fuel) enters the housing of electric filter 19 through inlet pipe. Contaminated dielectric fluid passes through apertures of current-carrying plates 42, is exposed to electrostatic fields occurring at power supply to studs 46 by high-voltage power supply. Current-carrying plates 42 are alternating with each other in one plate, and multidirectional voltage is supplied to even and odd current-carrying plates 42. There are dielectric spacers 43 between all current-carrying plates 42. One of the studs is connected to a positive potential, the other one is connected to a negative potential. Difference of potential is produced between the plates. When voltage of 1250 V-4750 V (depending on types of contaminations or their combination) is supplied, neutral particles of contaminations acquire positive and negative charges, attract each other, are enlarged and removed from liquid dielectric flow, precipitate and are retained in contamination collecting cells formed by current-carrying plates 42 and dielectric spacers 43. Purified dielectric fluid is removed from the housing through the corresponding outlet pipe with subsequent supply of fluid purified of mechanical impurities outside the apparatus.

Pressure relief valve 27 is for quick equalization of pressure in vacuum tank 20 in case of emergency. Vacuum tank 20 is equipped with main fluid level sensor 25, vacuum sensor 23 and vacuum meter 24, besides, tank 20 and mist extractor 29 are additionally equipped with level sensors 22, 30. There are drain valve 3, 4, 5 for servicing and storage of the apparatus.

When the claimed apparatus was in operation, maximum dehydrating and degassing efficiency was achieved at atomizer fluid inlet pressure minimum 6 atm, constant oil flow rate of 2 m3/h, fluid (oil) temperature 45-95° C. and vacuum tank pressure maximum −0.8 atm.

When atomizer fluid inlet pressure was below 6 atm, the atomizer failed to reach normal operating parameters, coarse suspended solids were formed instead of oil mist in the tank, that resulted in reducing dehydrating and degassing efficiency. When atomizer fluid inlet pressure was 18 atm (maximum test pressure), corrugated pipes started to break down, and no significant improvement of oil mist formation took place. When constant oil flow rate was below 2 m3/h, the vacuum pump started to flood with oil and oil mist was not formed in the tank, and when constant oil flow rate was above 2 m3/h, more powerful pump with higher capacity was required that would result in increasing dimensions and materials consumption. When fluid (oil) temperature is below 45° C., additional heater was required, that made the design more complicated, and when oil temperature was above 95° C., oil began to degrade and decompose.

In contrast to the prior art the claimed device ensures high oil pumping capability (2 m3/h versus analogue 0.5 m3/h), higher breakdown voltage of transformer oil after dehydration (86.8 kV versus analogue 59 kV), enables to reclaim efficiently hydraulic and dielectric fluids due to increasing the useful volume of the vacuum tank without increasing the dimensions thereof, reducing the dispersivity of fluid sprayed from the atomizer, stabilizing the electromagnetic field of the electric filter, increasing the surface area of the electric filter by creating a developed surface of current-carrying filter elements, it is characterized by improved reliability, ease of use, simplicity and reduced material consumption.

1. The apparatus for reclaiming hydraulic and dielectric fluids wherein it comprises a vacuum tank with an atomizer, a vacuum pump, a dielectric fluid feed pump and dielectric fluid removal pump, all of said pumps being connected to the tank by pipes, and an electric filter, wherein the atomizer is disposed in the lower part of the vacuum tank, is arranged vertically with a spray member oriented upward and consists of a T fitting with a lower inlet for fluid and with a lateral inlet for air, a mixing chamber disposed above the T fitting, and a spray member with a nozzle, said spray member being disposed above the mixing chamber, and the electric filter comprises a housing with an inlet pipe and outlet pipe, a high-voltage power supply, a composite unit disposed inside the housing and consisting of current-carrying plates and dielectric spacers with apertures for current-carrying and heavy-duty fastening elements, a front plug and rear plug, and current-carrying and heavy-duty fastening elements, wherein the surface of the current-carrying plates is provided with a porous ceramic dielectric coating.

2. Apparatus of claim 1 wherein atomizer fluid inlet pressure is minimum 6 atm.

3. Apparatus of claim 1 wherein the atomizer is hermetically seated in the lower part of the vacuum tank so that its upper part with a spray member and nozzle is inside the tank, and its lower part with T fitting, fluid and air inlets, and mixing chamber is disposed outside the tank.

4. Apparatus of claim 1 wherein vacuum tank pressure is maximum −0.8 atm.

5. Apparatus of claim 1 wherein temperature of fluid fed to the tank is 45-95° C.

6. Apparatus of claim 1 wherein two faceplates with openings are installed in the atomizer, one of them is for fluid and the other one is for air.

7. Apparatus of claim 1 wherein fluid faceplate is installed at fluid pipe end upstream from the mixing chamber, with a central opening for fluid passing through it to the mixing chamber.

8. Apparatus of claim 1 wherein air faceplate is hermetically seated in the upper part of T fitting with a central opening for a fluid pipe passing through it and with openings located on the circumference for air passing through them to the mixing chamber.

9. Apparatus of claim 1 wherein current-carrying plate aperture for current-carrying stud has inner teeth.

10. Apparatus of claim 1 wherein high-voltage power supply is current and voltage controlled and is configured on the outer part of the electric filter housing for short-circuit operation.

11. Apparatus of claim 1 wherein high-voltage power supply is configured to operate at 1250 V-4750 V.

12. Apparatus of claim 1 wherein through holes with a diameter sufficient for user's fingers penetration are arranged on plugs' face.

13. Apparatus of claim 1 wherein there is a seal on each plug circumference.
